(19) United States
(12) Patent Application Publication
(10) Pub. No.: US 2014/0139504 A1
(43) Pub. Date: May 22, 2014

(54) METHOD FOR DISPLAYING FLICKER PATTERN, METHOD FOR ADJUSTING COMMON VOLTAGE, AND LCD MODULE

(71) Applicant: SHENZHEN CHINA STAR OPTOELECTRONICS TECHNOLOGY CO., LTD, Shenzhen (CN)

(72) Inventors: Yong Zhang, Shenzhen (CN); Xiaoping Tan, Shenzhen (CN); Jiehui Qin, Shenzhen (CN)

(73) Assignee: SHENZHEN CHINA STAR OPTOELECTRONICS TECHNOLOGY CO., LTD, Shenzhen (CN)

(21) Appl. No.: 13/807,152

(22) PCT Filed: Nov. 23, 2012
(86) PCT No.: PCT/CN2012/085121

§ 371 Date: Dec. 27, 2012

(30) Foreign Application Priority Data
Nov. 22, 2012 (CN) 201210478516.8

(51) Int. Cl. G09G 3/00; G09G 3/36

(52) U.S. Cl. CPC G09G 3/006; G09G 3/3696
USPC 345/212

(57) ABSTRACT

The present disclosure provides a method of a liquid crystal display (LCD) module, a method for adjusting a common voltage, and an LCD module. The method includes saving a flicker pattern is used to adjust the common voltage in the timing controller (T-CON), setting a trigger condition for the flicker pattern, and displaying the flicker pattern on the LCD module when the LCD module meets the trigger condition.

### TECHNICAL FIELD

The present disclosure relates to the field of liquid crystal displays (LCDs), and more particularly to a method for displaying a flicker pattern of an LCD module, a method for adjusting a common voltage, and an LCD module.

### BACKGROUND

Voltage of a liquid crystal display (LCD) has a positive polarity and a negative polarity because an LCD device needs to be driven by alternating current (AC). Theoretically, amplitude of the positive polarity should be equal to amplitude of the negative polarity. However, deviation of a common voltage (VCOM) may occur because of different characteristics of each LCD panel, and errors may be generated in at manufacturing process of the LCD panel, which results in faults of a display of the LCD panel. The VCOM needs to be adjusted to avoid the deviation of the VCOM. For example, if the positive polarity voltage is 10 V the VCOM may be 5 V. However, in practice, the positive polarity voltage may become 9 V because of being affected by many external factors, at this moment, the VCOM needs to be adjusted to 4.5 V. Therefore, a flicker pattern test may be used to assist technical staff to adjust and get an optimum VCOM potential of the LCD panel.

As shown in FIG. 1 in order to make an LCD module display the flicker pattern on the LCD module, a power source should be added to light the LCD panel and a backlight module, and a pattern generator is needed to provide the flicker pattern. The pattern generator is a professional signal generator with high cost. In addition, because there are various flicker patterns for various LCD modules that are used to adjust the VCOM, the tester should select an appropriate flicker pattern. But, because there are so many kinds of flicker patterns, there are the disadvantages of low efficiency and easy error occurrence when the tester selects the flicker patterns.

### SUMMARY

In view of the above-described problems, the aim of the present disclosure is to provide a method of a liquid crystal display (LCD) module, a method for adjusting a common voltage, and an LCD module. A flicker pattern of the LCD module is saved in a timing controller without using a pattern generator to provide the flicker pattern. Thus, cost of the pattern generator is saved.

A first technical scheme of the present disclosure is that: a method of an LCD module, comprising steps:

saving the flicker pattern that is used to adjust a common voltage (VCOM) in the timing controller (T-CON);

setting a trigger condition for the flicker pattern; and

displaying the flicker pattern on the LCD module when the LCD module meets the trigger condition.

In one example, the flicker pattern is set as a default image displayed by the LCD module when the LCD module enters a free run mode, and the flicker pattern is displayed when the LCD module enters the free run mode.

In one example, a built-in self test (BIST) pin of the T-CON is connected to a ground to enable the LCD module to enter the free run mode and display the flicker pattern on the LCD module.

A second technical scheme of the present disclosure is that: a method for adjusting, a common voltage (VCOM), comprising steps:

saving, a flicker pattern that is used to adjust the VCOM in the timing controller (T-CON);

making a liquid crystal display (LCD) module trigger and display the flicker pattern on the LCD module; and

optimizing the VCOM.

In one example, the flicker pattern is set as a default image displayed by the LCD module when the LCD module enters a free run mode, when the LCD module enters the free run mode, the flicker pattern is displayed on the LCD module.

In one example, a built-in self test (BIST) pin of the T-CON is connected to a ground (GND) to enable the LCD module to enter the free run mode and display the flicker pattern on the LCD module.

In one example, the BIST pin of the T-CON is connected with a switch, and the switch is connected with a high level signal (VDD) and the GND. When the switch is switched to the GND, the LCD module enters the free run mode and displays the flicker pattern on the LCD module, when the switch is switched to the VDD, the LCD module is in a normal test mode.

A third technical scheme of the present disclosure is that: an LCD module comprises a timing controller (T-CON), and a flicker pattern that is used to adjust a common voltage is saved in the T-CON.

In one example, the flicker pattern is a default image of a free run mode of the LCD module.

Advantages of the present disclosure are summarized below: existing structure and technology are mainly used in the method of the present disclosure, where the LCD module displays the flicker pattern on the LCD module. There only needs to be a few hardware changes, only the flicker pattern that is used to adjust the VCOM is saved in the T-CON, and cost is not increased when one flicker pattern is saved in the T-CON because many patterns that are used to test a aging of the LCD module are already saved in the T-CON. The trigger condition is set for the flicker pattern, the flicker pattern is displayed by the LCD module when the LCD display meets the trigger condition, and then optimization of the VCOM is performed. Thus, traditional methods for displaying the flicker pattern on the LCD module do not need to be used, a pattern generator is not needed, and a number of apparatuses needed in production line is reduced. Moreover, because the flicker pattern is owned by the T-CON and is automatically displayed without being selected, number of errors is reduced.

### BRIEF DESCRIPTION OF FIGURES

FIG. 1 is a schematic diagram of a displayed flicker pattern of a liquid crystal display (LCD) module in the prior art; and

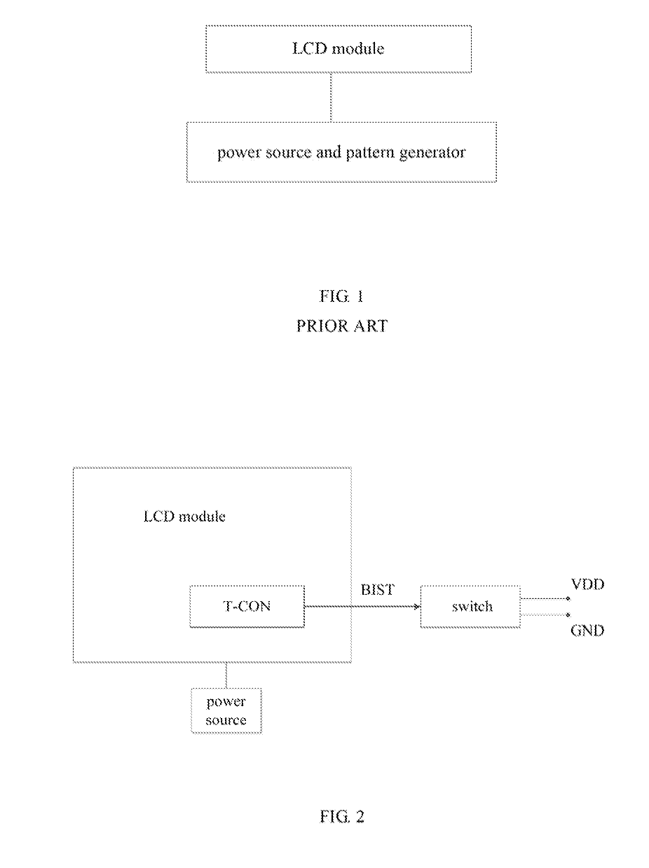

FIG. 2 is a schematic diagram of a displayed flicker pattern of an example of a liquid crystal display (LCD) module of the present disclosure.

### DETAILED DESCRIPTION

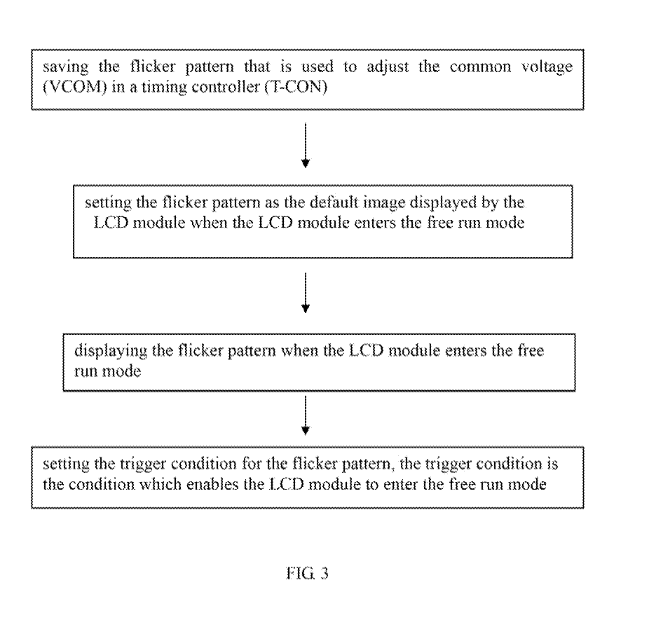

The present disclosure provides a method that a liquid crystal display (LCD) module displays a flicker pattern on the LCD module. FIG. 2 shows an example of the method, and the method comprises steps:

saving a flicker pattern that is used to adjust a common voltage (VCOM) in a timing controller (T-CON);

setting a trigger condition for the flicker pattern; and

displaying the flicker pattern on the LCD module when the LCD module meets the trigger condition.

Existing structure and technology are mainly used in the method of the present disclosure, where the LCD module displays the flicker pattern on the LCD module. There only needs to be a few hardware changes, only the flicker pattern that is used to adjust the VCOM is saved in the T-CON, and cost is not increased when one flicker pattern is saved in the T-CON because many patterns that are used to test ageing of the LCD module are already saved in the T-CON. The trigger condition is set for the flicker pattern, the flicker pattern is displayed by the LCD module when the LCD display meets the trigger condition, and then optimization of the VCOM is performed. Thus, traditional methods for displaying the flicker pattern do not need to be used, a pattern generator is not needed, and a number of apparatuses needed in production line is reduced. Moreover, because the flicker pattern is owned by the T-CON and is automatically displayed without being selected, number of errors is reduced.

In the example, the flicker pattern is set as a default image displayed by the LCD module when the LCD module enters a free run mode, and the flicker pattern is displayed on the LCD module when the LCD module enters the free run mode. The trigger condition is a condition which enables the LCD module to enter the free run mode.

The LCD module of the present disclosure comprises the T-CON. One flicker pattern that is used to adjust the VCOM is saved in the T-CON. The LCD module displays the flicker pattern on the LCD module when the LCD module meets the trigger condition. In the aforementioned method, the flicker pattern is set as the default image displayed by the LCD module when the LCD module enters the free run mode. The LCD module displays the flicker pattern on the LCD module when the LCD module enters the free run mode.

In the prior art, when the T-CON is in an abnormal state, such as in a state of built-in self test (BIST) being disabled, a state of having no low-voltage differential signaling (LVDS) clock, or a state of having no data enable signal, the LCD module may enter the free run mode. At this moment, the LCD panel displays a black image. Because a default condition of a BIST pin of the T-CON is a high level signal (VDD), if the BIST pin of the T-CON is set to be connected with a ground (GND), the T-CON is in the abnormal state, namely the LCD module enters the free run mode and displays the default image. The present disclosure uses the flicker pattern to replace the black image, namely when the LCD module enters the free run mode, the flicker pattern is displayed as the image, then optimization of the VCOM is performed. Thus, the traditional methods for displaying the flicker pattern do not need to be used, and the pattern generator is not needed. Moreover, because the flicker pattern is owned by the T-CON and automatically displayed without being selected, errors may not occur. The method for displaying the flicker pattern has the advantages of simplicity, easy achievement, and high efficiency.

The present disclosure further provides a method for adjusting a common voltage (VCOM). When the LCD module triggers and displays the flicker pattern using the method mentioned above, the common voltage may be optimized.

In the example, the BIST pin of the T-CON is connected with a switch, and the switch is connected with the VDD and the GND. When the switch is switched to the GND, the LCD module enters the free run mode and displays the flicker pattern on the LCD module, and when the switch is switched to the VDD, the LCD module is in a normal test mode. Because adjusting the VCOM is only one workstation of the production line of the LCD module, and the T-CON enters the abnormal state only in the workstation of adjusting the VCOM, the switch should be switched to the VDD after task in the workstation of adjusting the VCOM is accomplished, which enable the T-CON to return to the normal state and does not affect subsequent workstations.

Optionally, there are also other methods for enabling the LCD module to enter the free run mode, for example enabling the T-CON to enter a state of BIST being disabled, a state of having no LVDS clock, or a state of having no data enable signal.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A method of a liquid crystal display (LCD) module, comprising:
saving a flicker pattern that is used to adjust a common voltage (VCOM) in a timing controller (T-CON);
setting a trigger condition for the flicker pattern; and
displaying the flicker pattern on the LCD module when the LCD module meets the trigger condition.

2. The method of the liquid crystal display (LCD) module of claim 1, wherein the flicker pattern is set as a default image displayed, by the LCD module when the LCD module enters a free run mode, and the flicker pattern is displayed on the LCD module when the LCD module enters the free run mode.

3. The method of the liquid crystal display (LCD) module of claim 2 wherein a built-in self test (BIST) pin of the T-CON is connected to a ground to enable the LCD module to enter the free run mode and display the flicker pattern.

4. A method for adjusting a common voltage (VCOM), comprising:
saving a flicker pattern that is used to adjust the VCOM in a timing controller (T-CON);
making a liquid crystal display (LCD) module trigger and display the flicker pattern on the LCD module; and
optimizing the VCOM.

5. The method for adjusting the common voltage of claim 4, wherein the flicker pattern is set as a default image displayed by the LCD module when the LCD module enters a free run mode, when the LCD module enters the free run mode, the flicker pattern is displayed on the LCD module.

6. The method for adjusting the common voltage of claim 5, wherein a built-in self test (BIST) pin of the T-CON is connected to a ground (GND) to enable the LCD module to enter the free run mode and display the flicker pattern on the LCD module.

7. The method for adjusting the common voltage of claim 6, wherein the BIST pin of the T-CON is connected with a switch, and the switch is connected with a high level signal (VDD) and the GND; when the switch is switched to the GND, the LCD module enters the free run mode and displays the flicker pattern; when the switch is switched to the VDD, the LCD module is in a normal test mode.

8. A liquid crystal display (LCD) module, comprising:
a timing controller (T-CON) wherein a flicker pattern, which is used to adjust common voltage (VCOM), is saved in the T-CON.

9. The liquid crystal display (LCD) module of claim 8, wherein the flicker pattern is a default image of a free run mode of the LCD module.
